(19) United States
(12) Patent Application Publication
(10) Pub. No.: US 2008/0218249 A1
(43) Pub. Date: Sep. 11, 2008

(54) Semiconductor device and trimming method therefor

(76) Inventor: Keisuke Uemura, Chiba-shi (JP)

Correspondence Address: BRUCE L. ADAMS, ESQ;ADAMS & WILKS, SUITE 1231, 17 BATTERY PLACE, NEW YORK, NY, 10004, US

(21) Appl. No.: 12/070,693

(22) Filed: Feb. 20, 2008

(30) Foreign Application Priority Data
Feb. 21, 2007 (JP) 2007-040574

(51) Int. Cl. H01H 37/76

(52) U.S. Cl. 327/525

(57) ABSTRACT

Provided is a semiconductor device including a divisional resistor having a fuse, and a divisional resistor for measuring relative accuracy which is obtained by eliminating the fuse from the divisional resistor having the fuse. Characteristic values of the divisional resistor for measuring relative accuracy are measured so as to obtain trimming data, and then the divisional resistor having the fuse is trimmed, to thereby obtain a semiconductor device with highly precise characteristics.

### BACKGROUND OF THE INVENTION

1. Field of the Invention

The present invention relates to a semiconductor device with high accuracy and a trimming method constituting a part of a method of manufacturing the semiconductor device.

2. Description of the Related Art

In order to improve accuracy of characteristic values of a semiconductor device, there is employed a method in which the characteristic values are independently measured, and fuses formed on the semiconductor substrate are cut by burning with a laser beam based on the measured values, which is called trimming by cutting fuses to change a divisional ratio between resistors so as to adjust the characteristic values. In general, the divisional resistors each have a given size, that is, a given resistance, permitting the trimming to be performed on the premise that resistors having, for example, the same size have the same resistance.

The method is described with reference to FIG. 4. FIG. 4 schematically shows a voltage detection circuit including divisional resistors 101 and a comparator 104. Before the trimming is performed, since all the fuses 102 are connected, the upper potential and the lower potential of the fuses are equal. In this case, voltage of an input 105 is directly applied to a positive terminal of the comparator 104. Accordingly, when the voltage of the input 105 is equal to the voltage at a reference voltage circuit 103, voltage at an output 106 is inverted.

Next, operation after the trimming is described with reference to FIG. 5. An upper end and a lower end of the cut-off fuse 107 are connected through the divisional resistor. In this case, a divided voltage of the input 105 by resistors is applied to the positive terminal of the comparator 104. If a resistance of a divisional resistor disposed in parallel with the cut-off fuse 107 is equal to a resistance of a resistor which is originally present, the voltage at the input 105 is divided just in half. Accordingly, when the voltage at the reference voltage circuit 103 balances a half voltage of the voltage at the input 105, that is, when the voltage at the input 105 becomes twice as large as that of the reference voltage circuit 103, the voltage at the output 106 is inverted.

In this manner, by use of the divisional resistor and the fuse disposed in parallel with the divisional resistor, a divisional ratio determined by resistors is changed by laser trimming, whereby a circuit for finely adjusting the characteristic values of the semiconductor device can be realized (See JP H9-260591A).

The divisional ratio between the divisional resistors is adjusted by the trimming to thereby adjust the characteristic values on the premise that the divisional resistors each have the constant resistance value as long as the divisional resistors have the same size. However, depending on an actual method of manufacturing resistors, for example, polysilicon resistors, the resistances may be varied even when the resistors are intended to have the same size, that is, the same resistance. This seems to occur due to a difference in line width caused in an etching process, a difference in distribution of an impurity concentration, a difference in degree of activation, and the like. The deviation in resistance may become significantly larger, as miniaturization advances further.

In general, a ratio or percentage of a difference between adjacent resistors with respect to a resistance is referred to as a relative accuracy which is used as an index of the accuracy in the divisional resistors.

From the above-mentioned causes, deterioration in the relative accuracy of the divisional resistors constituting the circuit leads to unsuccessful satisfaction of the required accuracy. In particular, when a small-size divisional resistor is produced according to the miniaturization, the relative accuracy tends to deteriorate more. Further, the relative accuracy of the divisional resistor within a wafer tends to have a distribution in a plane of the wafer, which causes such a phenomenon that the relative accuracy varies depending on the position of the divisional resistor within the wafer. Due to the phenomenon, there appear a region in which the characteristics value can be satisfactorily adjusted and a region in which the characteristics value cannot be satisfactorily adjusted, whereby a certain failure pattern is formed in some cases.

### SUMMARY OF THE INVENTION

In order to solve the above-mentioned problems, the present invention provides a method of manufacturing a semiconductor device, including the steps of: fabricating a divisional resistor for measuring relative accuracy at a position inside or outside the semiconductor device; measuring the relative accuracy of the fabricated divisional resistor; and adjusting characteristic values of a product with high accuracy based on the relative accuracy and the characteristic values of the product.

According to the present invention, the characteristic values of the semiconductor device can be adjusted more precisely than conventional cases, and a semiconductor device with higher accuracy can be realized.

### BRIEF DESCRIPTION OF THE DRAWINGS

In the accompanying drawings:

FIG. 1 is a schematic diagram showing a semiconductor device according to a first embodiment of the present invention;

FIG. 2 is a schematic diagram showing a semiconductor device according to a second embodiment of the present invention;

FIG. 3 is a schematic diagram showing a semiconductor device according to a third embodiment of the present invention;

FIG. 4 is a schematic diagram showing a state before trimming is performed; and

FIG. 5 is a schematic diagram showing a state after trimming is performed.

### DETAILED DESCRIPTION OF THE PREFERRED EMBODIMENTS

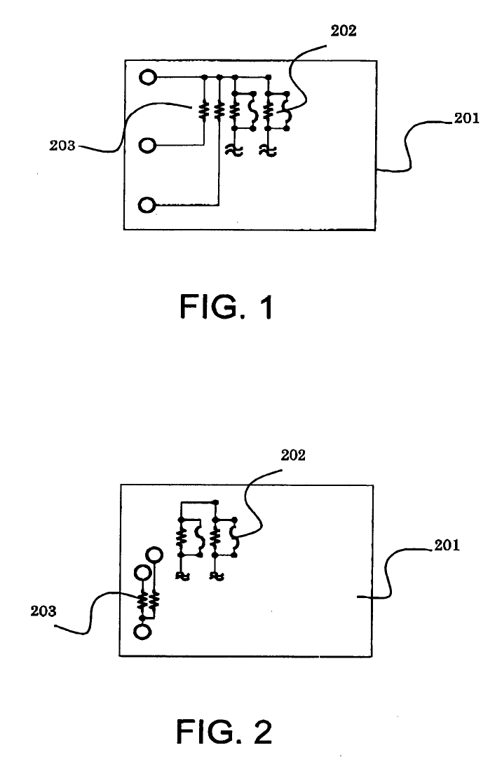

Hereinafter, embodiments of the present invention will be described with reference to FIGS. 1 to 3.

### First Embodiment

FIG. 1 is a schematic diagram showing a divisional resistor portion of a semiconductor device according to a first embodiment of the present invention.

A semiconductor device 201 includes divisional resistors 202 having a fuse and divisional resistors for measuring relative accuracy 203 which are disposed in the same circuit so as to be adjacent to each other. Each of the divisional resistors for measuring relative accuracy 203 is formed so as to have a resistance value equal to that of each of the divisional resistors 202 having the fuse. In other words, each of the divisional resistor for measuring relative accuracy 203 is obtained by eliminating the fuse from each of the divisional resistors 202.

In first measurement, characteristic values of each of the divisional resistors for measuring relative accuracy 203 of the semiconductor device 201 thus structured are first measured, to thereby obtain a resistance value of each of the resistors with accuracy. Then, the relative accuracy between the divisional resistors is obtained. Based on the relative accuracy thus obtained, trimming data on each fuse is calculated. After that, the fuse determined based on the trimming data is trimmed, whereby a semiconductor device with higher accuracy can be realized.

It is necessary to provide a pad for directly measuring the relative accuracy. In a case where there is such an adverse effect that a circuit operation becomes unstable due to the presence of the pad, there can be employed a method in which the provided fuse may be cut off after the measurement is finished so as to physically separate the pad from an internal circuit.

### Second Embodiment

FIG. 2 is a schematic diagram showing a divisional resistor portion of a semiconductor device according to a second embodiment of the present invention.

In the semiconductor device 201, the divisional resistors 202 each having the fuse are disposed near the divisional resistors for measuring relative accuracy 203. A difference from the first embodiment resides in that each of the divisional resistors 202 having the fuse is electrically separated from each of the divisional resistors for measuring relative accuracy 203. The divisional resistors 202 each having the fuse and the divisional resistor for measuring relative accuracy 203 are electrically separated from each other, but are disposed close to each other so as to obtain each resistance value. As compared with the first embodiment, the second embodiment is advantageous in that flexibility in arrangement of the divisional resistors for measuring relative accuracy 203 is high.

Regarding the measurement, also in the second embodiment, similarly to the first embodiment, in the first measurement, the characteristic values of each of the divisional resistors for measuring relative accuracy 203 of the semiconductor device 201 thus structured are measured, to thereby obtain the resistance value of each of the resistors with accuracy. Then, the relative accuracy between the divisional resistors is obtained. Based on the relative accuracy thus obtained, the trimming data on each fuse is calculated. After that, the fuse determined based on the trimming data is trimmed, whereby a semiconductor device with higher accuracy can be realized.

### Third Embodiment

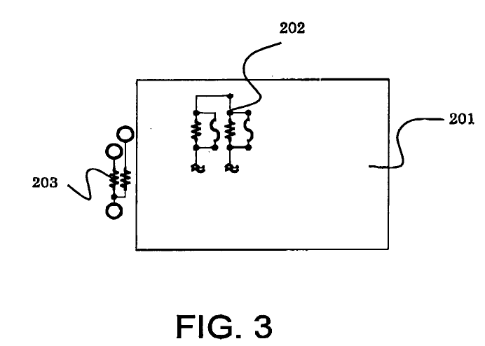

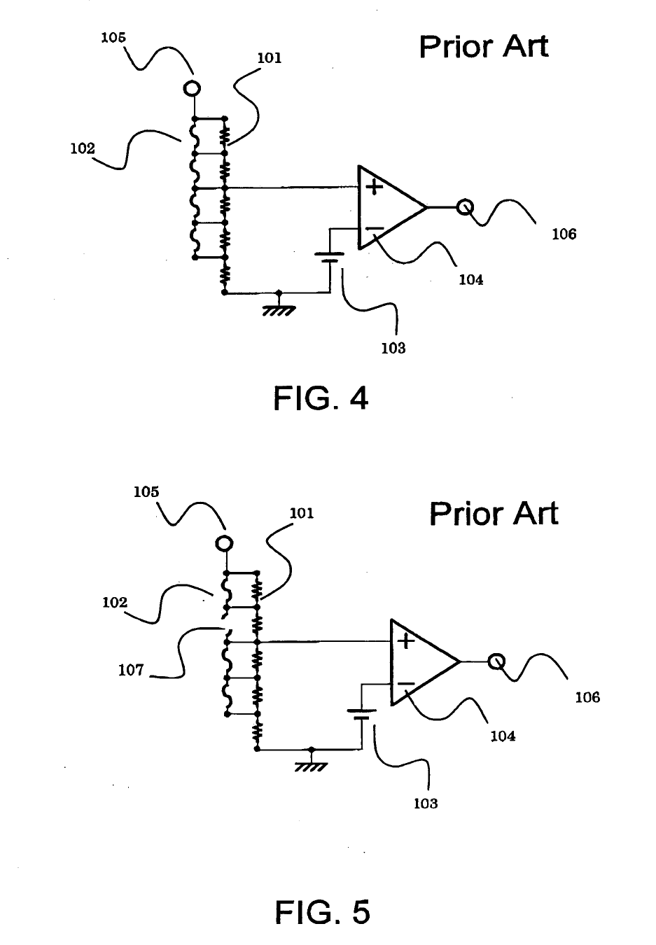

FIG. 3 is a schematic diagram showing a divisional resistor portion of a semiconductor device according to a third embodiment of the present invention.

The divisional resistors 202 each having the fuse are disposed in an element region which is formed inside the semiconductor device 201. Meanwhile, the divisional resistors for measuring relative accuracy 203 are each disposed in a region such as a scribe line region, which corresponds to an outer periphery of the element region forming the semiconductor device. Further, the divisional resistors for measuring relative accuracy 203 can be disposed in a region of a test element group called TEG. In addition, the divisional resistors for measuring relative accuracy 203 can be disposed also in another semiconductor device different from the subject semiconductor device. Note that the divisional resistors in each of the above-mentioned regions are preferably disposed as close to each other as possible.

The divisional resistors for measuring relative accuracy 203 are each used for obtaining the trimming data on each fuse, and each become an unnecessary area after the fuse is trimmed. Accordingly, the divisional resistors for measuring relative accuracy 203 are not necessarily provided within the semiconductor device. The divisional resistors for measuring relative accuracy 203 are disposed outside the semiconductor device, whereby the size of the semiconductor device can be kept small. A difference from the first embodiment resides in that each of the divisional resistors 202 having the fuse is electrically separated from each of the divisional resistors for measuring relative accuracy 203. The divisional resistors 202 each having the fuse and the divisional resistor for measuring relative accuracy 203 are electrically separated from each other, but are disposed close to each other so as to obtain each resistance value. As compared with the first embodiment, the third embodiment is advantageous in that the flexibility in arrangement of the divisional resistors for measuring relative accuracy 203 is high.

Regarding the measurement, also in the third embodiment, similarly to the first embodiment, in the first measurement, the characteristics value of each of the divisional resistors for measuring relative accuracy 203 of the semiconductor device 201 thus structured are measured, to thereby obtain the resistance value of each of the resistors with accuracy. Then, the relative accuracy between the divisional resistors is obtained. Based on the relative accuracy thus obtained, the trimming data on each fuse is calculated. After that, the fuse determined based on the trimming data is trimmed, whereby a semiconductor device with higher accuracy can be realized.

What is claimed is:

1. A semiconductor device, comprising
a resistor circuit including:
a first divisional resistor having a fuse; and
a second divisional resistor for measuring relative accuracy designed to have a same resistance as the first divisional resistor, and having no fuse, wherein:
trimming data of the fuse is calculated based on a measured characteristic value of the second divisional resistor; and
the first divisional resistor is trimmed based on the trimming data.

2. A semiconductor device according to claim 1, wherein the first divisional resistor having the fuse and the second divisional resistor for measuring relative accuracy are disposed so as to be adjacent to each other.

3. A semiconductor device according to claim 1, wherein:
the first divisional resistor having the fuse is disposed in an element region of the semiconductor device; and
the second divisional resistor for measuring relative accuracy is disposed in a region outside the element region.

4. A semiconductor device according to claim 3, wherein the region where the second divisional resistor for measuring relative accuracy is disposed is in a scribe line region.

5. A semiconductor device according to claim 3, wherein the region where the second divisional resistor for measuring relative accuracy is disposed is in another adjacent semiconductor device.

6. A semiconductor device according to claim 3, wherein the region where the second divisional resistor for measuring relative accuracy is disposed is in a test element group formed outside the semiconductor device.

7. A trimming method for a resistor circuit of a semiconductor device, the resistor circuit including: a first divisional resistor having a fuse; and a second divisional resistor for measuring relative accuracy having no fuse, the trimming method comprising the steps of:
measuring characteristic values of the second divisional resistor for measuring relative accuracy;
obtaining relative accuracy;
calculating trimming data on the fuse based on the relative accuracy; and
trimming the first divisional resistor having the fuse based on the trimming data.
